(19) United States
(12) Patent Application Publication
(10) Pub. No.: US 2024/0153688 A1
(43) Pub. Date: May 9, 2024

(54) CORE AND ELECTROMAGNETIC DEVICE PROVIDED WITH CORE

(71) Applicant: FANUC CORPORATION, Yamanashi (JP)

(72) Inventor: Akira NISHIFUKUMOTO, Yamanashi (JP)

(21) Appl. No.: 18/548,550

(22) PCT Filed: Mar. 3, 2022
(86) PCT No.: PCT/JP2022/009193

§ 371 Date: Nov. 3, 2023

(30) Foreign Application Priority Data
Mar. 9, 2021 (JP) 2021-037639

(51) Int. Cl. H01F 3/10; H01F 27/30; H02K 3/34

(52) U.S. Cl. CPC H01F 3/10; H01F 27/306; H02K 3/345

(57) ABSTRACT

Provided are a core and an electromagnetic device capable of suppressing the occurrence of a partial discharge. A plurality of slots (23) into which coils (30) are to be inserted are formed in one surface of a core (20). Recessed sections (29) extending towards another surface of the core (20) are formed in the bottoms of the plurality of slots. An electromagnetic device (1) includes: the core (20); the coils (30, 31 to 33) inserted into the plurality of slots; insulating paper (35) surrounding the coils; and an insulating resin section (39) covering the entire core.

### FIELD

The present invention relates to a core and an electromagnetic device comprising a core.

### BACKGROUND

Generally, a stator of a motor comprises a substantially annular core and a plurality of coils inserted into a plurality of slots formed in the inner peripheral surface side of the core. Refer to, for example, Patent Literature 1 (Japanese Unexamined Patent Publication (Kokai) No. 2018-78749).

Furthermore, in recent years, linear motors, which are easy to drive at high speeds and excellent in quietness, have become popular as drive units for various industrial machines, such as spindle/table feed mechanisms for machine tools and magnetic head drive mechanisms for OA equipment. The slider of such a linear motor comprises a substantially linear core and a plurality of coils inserted into a plurality of slots formed in one surface side of the core. Refer to, for example, Patent Literature 2 (WO 2012/147212).

The coils of electromagnetic devices such as the motor and linear motor described above are enclosed within an insulating paper. Furthermore, after the coil is arranged, the entire periphery of the substantially circular or substantially linear core is surrounded with a resin part.

### CITATION LIST

### Patent Literature

[PTL 1] Japanese Unexamined Patent Publication (Kokai) No. 2018-78749
[PTL 2] WO 2012/147212

### SUMMARY

### Technical Problem

When forming a resin part, liquid resin is decompressed to defoam the gas mixed in the liquid resin. However, if defoaming is insufficient and/or the liquid resin is not sufficiently filled into the slots, voids will occur inside the slots.

When an electromagnetic device includes an armature in which voids are formed, partial discharge may occur in the void, resulting in breakdown of the insulation around the void.

Thus, a highly reliable core capable of suppressing the occurrence of partial discharge and an electromagnetic device comprising such a core are desired.

### Solution to Problem

According to a first aspect of the present disclosure, there is provided a core, wherein a plurality of slots into which coils are to be inserted are formed in one surface of the core, and recesses extending toward the other surface of the core are formed in bottom parts of the plurality of slots.

### Advantageous Effects of Invention

In the first aspect, since recesses are formed in the bottom parts of the slots into which the coils are to be inserted, when the resin part covering the entire armature including the core is formed, air is guided to the recesses to generate voids therein. Thus, even if a partial discharge occurs around the voids, the recess is spaced from the location where the electric field concentrates, whereby a sufficient insulation distance between the coils and the core can be secured, and the occurrence of partial discharge can be suppressed. As a result, a highly reliable core can be provided.

The objects, features, and advantages of the present invention will be further clarified by way of the descriptions of the embodiments below in conjunction with the attached drawings.

### BRIEF DESCRIPTION OF DRAWINGS

FIG. 1 is a cross-sectional view of a linear motor as an electromagnetic device according to a first embodiment.

FIG. 2A is a perspective view of the armature of the linear motor shown in FIG. 1.

FIG. 2B shows a first magnetic plate used for forming a core of an armature.

FIG. 2C shows a second magnetic plate used for forming a core of an armature.

FIG. 3A is a cross-sectional view of a motor as an electromagnetic device according to a second embodiment.

FIG. 3B shows a magnetic plate used for forming a core of a stator.

FIG. 4A is a perspective view of a reactor as an electromagnetic device according to a third embodiment.

FIG. 4B is a top view of a reactor.

FIG. 4C shows a magnetic plate used for forming a core of a reactor.

FIG. 4D shows another magnetic plate used for forming a core of a reactor.

FIG. 5A is a view showing a recess according to another embodiment.

FIG. 5B is a view showing a recess according to yet another embodiment.

FIG. 6 is a partial cross-sectional view of an armature of a linear motor of the prior art.

### DESCRIPTION OF EMBODIMENTS

The embodiments of the present invention will be described below with reference to the attached drawings. In the drawings, corresponding constituent elements have been assigned similar or identical reference signs.

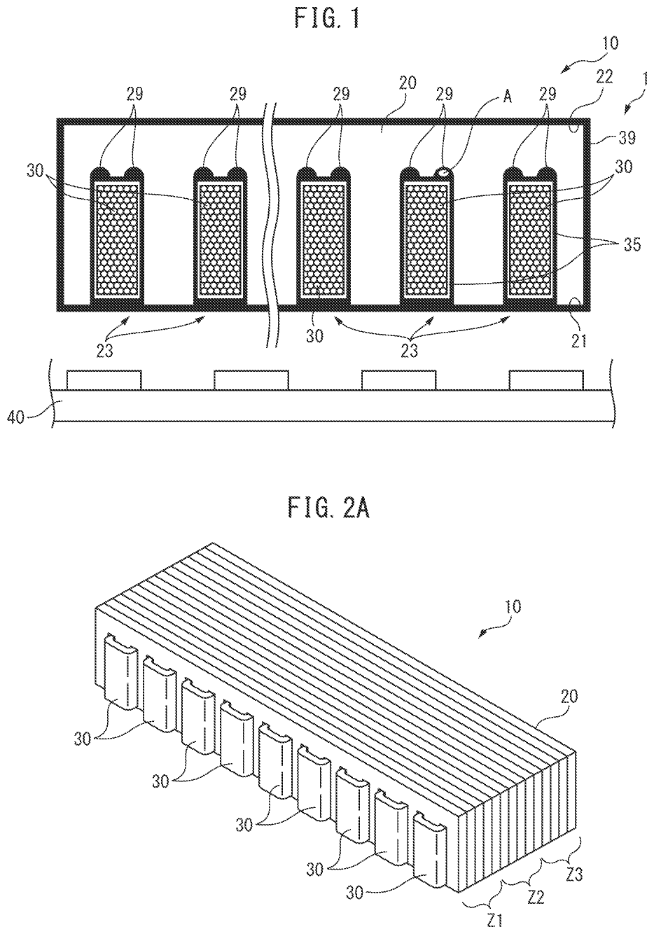

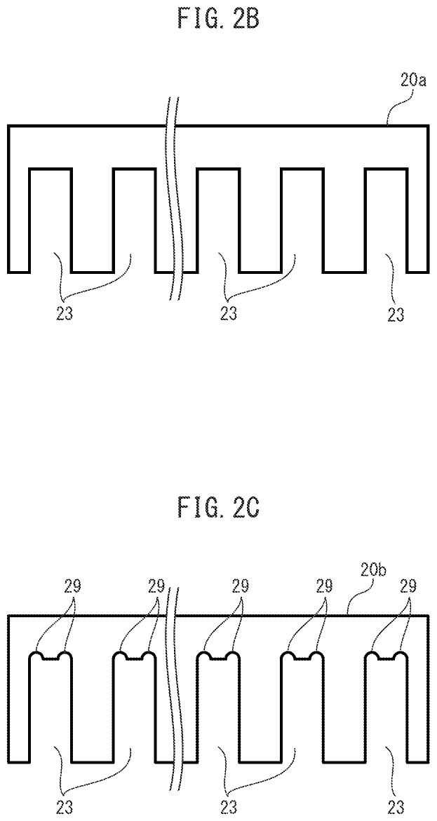

FIG. 1 is a cross-sectional view of a linear motor as an electromagnetic device according to a first embodiment, and FIG. 2A is a perspective view of a slider of the linear motor shown in FIG. 1. As shown in FIG. 1, the linear motor 1 as an electromagnetic device comprises an armature 10 primarily including a rectangular core 20 and a plurality of coils 30, and a magnet plate 40 on which a plurality of magnets are arranged side by side.

The core 20 of the armature 10 has one surface 21 and another surface 22, and a plurality of rectangular slots 23 into which each of the plurality of coils 30 is to be inserted are formed in the one surface 21. Each of the coils 30 is inserted into the respective slot 23 while being surrounded by insulating paper 35. Thus, coils 30 and core 20 are electrically insulated. As can be understood from FIG. 1, a resin part 39 is formed around the entire armature 10.

FIGS. 2B and 2C are views showing a first magnetic plate and a second magnetic plate, respectively, used to form the core of the armature. A plurality of slots 23 are formed in one side of the magnetic plate 20a corresponding to the one surface 21 of the core 20, as shown in FIG. 2B.

Likewise, a plurality of slots 23 are similarly formed in the magnetic plate 20b shown in FIG. 2C. Further, at least one recess 29 is formed at a position corresponding to the bottom part of each slot 23. These recesses 29 at least partially extend toward the other surface 22 side (back yoke side) of the core 20. As shown in FIG. 2C, recesses 29 are formed at both ends of the side corresponding to the bottom part of slot 23.

Referring again to FIG. 2A, the core 20 is formed by stacking a plurality of magnetic plates such as iron plates, carbon steel plates, or electromagnetic steel plates. In FIG. 2A, regions Z1 to Z3 are set with respect to core 20 in the stacking direction of the magnetic plates. Region Z1 includes one side of the core 20 corresponding to the first magnetic plate among the plurality of magnetic plates to be laminated. Region Z3 includes the other side of core 20 corresponding to the last magnetic plate among the plurality of magnetic plates to be laminated. Region Z2 is an middle region interposed between region Z1 and region Z3.

In the present disclosure, the portions of the core 20 corresponding to regions Z1 and Z3 are formed by stacking a plurality of magnetic plates 20a. The portion of the core 20 corresponding to region Z2 is formed by stacking a plurality of magnetic plates 20b.

Recesses 29 are not formed in the portions of the core 20 corresponding to region Z1 and region Z3. Thus, in the core 20 of the first embodiment, recesses 29 are formed only in the middle region Z2 in the stacking direction.

When forming the resin part 39, the entire armature 10, in which the coils 30 are inserted into the slots 23, is immersed in an insulating liquid resin. At this time, the liquid resin enters the interiors of the slots 23 and fills the spaces between the coils 30, the insulating paper 35, and the slots 23. After defoaming the liquid resin by reducing the pressure, the armature 10 is removed from the liquid resin to cure the resin. As a result, the resin part 39 is formed. When the resin is cured, the coil 30, insulating paper 35, and slots 23 are affixed together.

When the armature 10 is removed from the liquid resin, the gas entrained in the liquid resin and/or the gas trapped in the slots 23 by the insulating paper 35 moves upward in the vertical direction. Thus, such gas is guided from slots 23 to the recesses 29, and remains in recesses 29. When the resin is cured, the gas forms voids A within the recesses 29.

A partial discharge may occur around the void A during driving of the linear motor 1 comprising the armature 10, in which the voids A are formed in the slots 23. However, in the present disclosure, the recesses 29 are formed, and the recesses 29 are separated from the locations in the linear motor 1 where the electric field concentrates. Thus, a sufficient insulation distance between the coils 30 and the core 20 can be secured, whereby the occurrence of partial discharge can be suppressed. Therefore, a highly reliable core 20 and a linear motor 1 as an electromagnetic device comprising such a core 20 can be provided.

The recesses 29 preferably extend at least partially from the bottom parts of the slots 23 toward the other surface 22 side of the core 20 so that the voids A are formed within the recesses 29. Though the recesses 29 shown in FIG. 1 are semicircular, the recesses 29 are not limited to a semicircular shape. The recesses 29 may have another shape that at least partially extends from the bottom parts of the slots 23 toward the other surface 22 side of the core 20.

In the first embodiment, the magnetic plate 20b comprising recesses 29 is used only in the middle region Z2 of the core 20. The reason for this is that the voids A tend to occur in the central portion in the stacking direction of the magnetic material.

In other words, it is not necessary to use the magnetic plate 20b in the other regions Z1 and Z3. Thus, the number of magnetic plates 20b having recesses 29 can be minimized. Therefore, the highly reliable core 20 described above can be provided with only a slight increase in terms of the production cost of the core 20.

Note that in an unillustrated embodiment, the core 20 may be formed using a plurality of magnetic plates 20b in all of regions Z1 to Z3. In this case, the occurrence of partial discharge can be further suppressed. Alternatively, after forming the core 20 using only the plurality of magnetic plates 20a in all of regions Z1 to Z3, the recesses 29 may be formed in the magnetic plates 20a in the middle region Z2 or the magnetic plates 20a in all of regions Z1 to Z3 by machining. These cases are also included in the scope of the present disclosure.

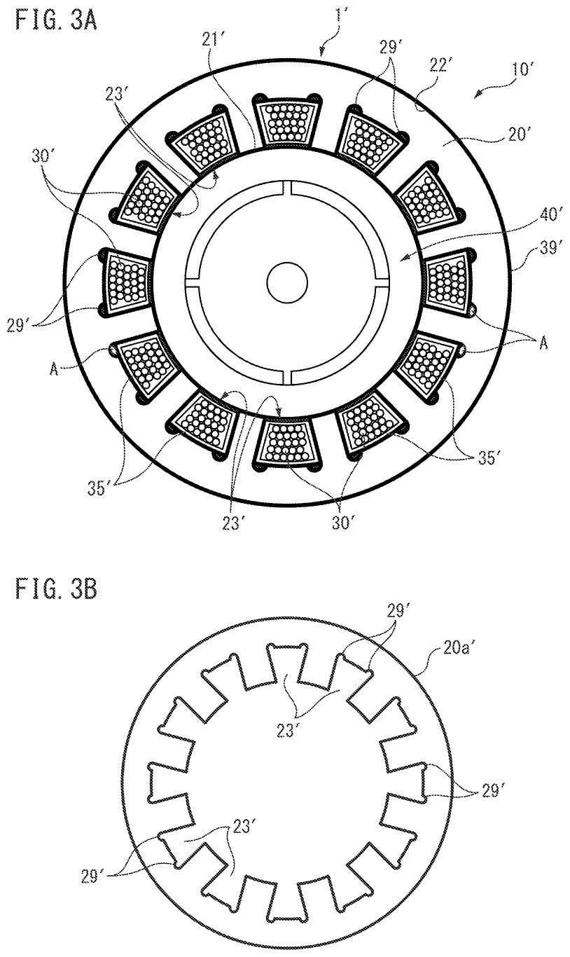

FIG. 3A is a cross-sectional view of a motor as an electromagnetic device according to a second embodiment. Motor 1′ as an electromagnetic device comprises a stator 10′ primarily including an annular core 20′ and a plurality of coils 30′, and a rotor 40′ on which a plurality of magnets are arranged side by side on the outer peripheral surface thereof.

As shown in FIG. 3A, a plurality of substantially fan-shaped slots 23′ into which the plurality of coils 30′ are to be inserted are formed at regular intervals in the inner peripheral surface of the core 20′. Each coil 30′ is inserted into the respective slot 23′ while being surrounded by insulating paper 35′. Thus, the coils 30′ and the core 20′ are electrically insulated. As described above, a resin part 39′ is formed around the entire stator 10′.

In the same manner as the first embodiment, the core 20′ is formed by stacking a plurality of magnetic plates such as iron plates, carbon steel plates, or electromagnetic steel plates. FIG. 3B is a view showing a magnetic plate used to form the core of the stator. A plurality of substantially fan-shaped slots 23′ are formed in the inner peripheral surface of the magnetic plate 20a′ shown in FIG. 3B.

At least one recess 29′ is formed in each of the plurality of notches at positions corresponding to the bottom parts of each slot 23′. These recesses 29′ extend at least partially from the bottom parts of slots 23′ toward the outer peripheral surface of core 20′. As shown in FIG. 3B, recesses 29′ are formed at both ends of the side corresponding to the bottom parts of slots 23′. In the second embodiment, the recesses 29′ are formed in all of the plurality of magnetic plates 20a′ constituting the core 20′. In other words, the core 20′ is composed only of a plurality of magnetic plates 20a′ having recesses 29′, and no magnetic plates free of recesses 29′ (not illustrated) are used.

The entire stator 10′, in which the coils 30′ are inserted into the slots 23′, is immersed in a liquid resin so as to form the resin part 39′ shown in FIG. 3A. The stator 10′ is removed from the liquid resin in the axial direction of the core 20′, i.e., in the stacking direction of the magnetic plates. At this time, the liquid resin flows axially downward along slots 23′ and recesses 29′. Most of the gas entrained in the liquid resin and/or trapped in the slots 23′ by the insulating paper 35′ flows axially downward along with the liquid resin. Part of the gas is guided from the slots 23′ to the recesses 29′, which have a lower flow resistance, together with the liquid resin, and remains in the recesses 29′ to form the voids A. It can be understood that the motor 1′ formed in this manner also provides the same effects as described above.

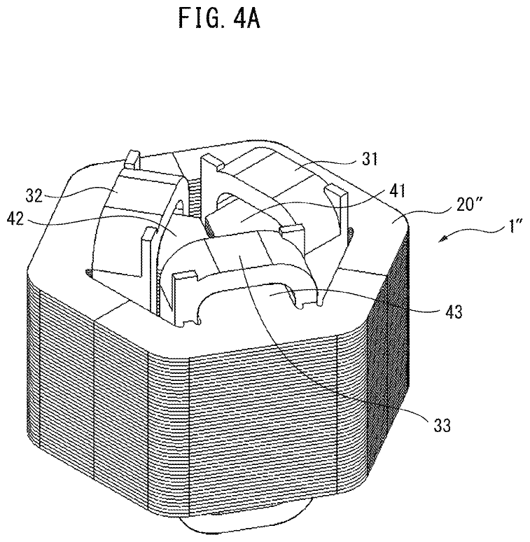

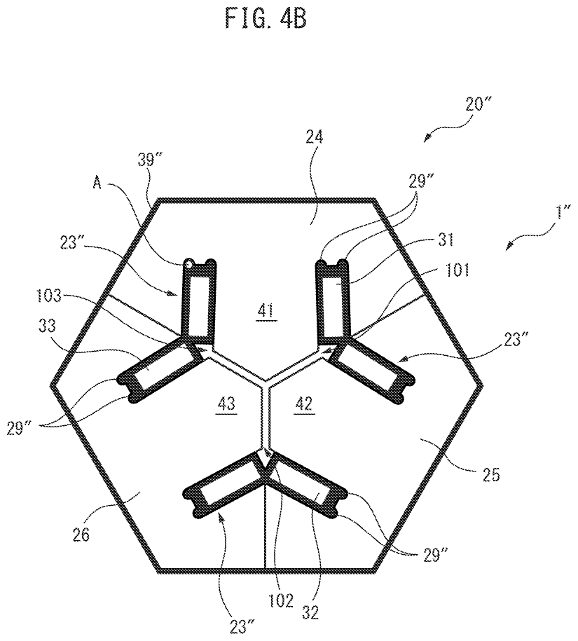

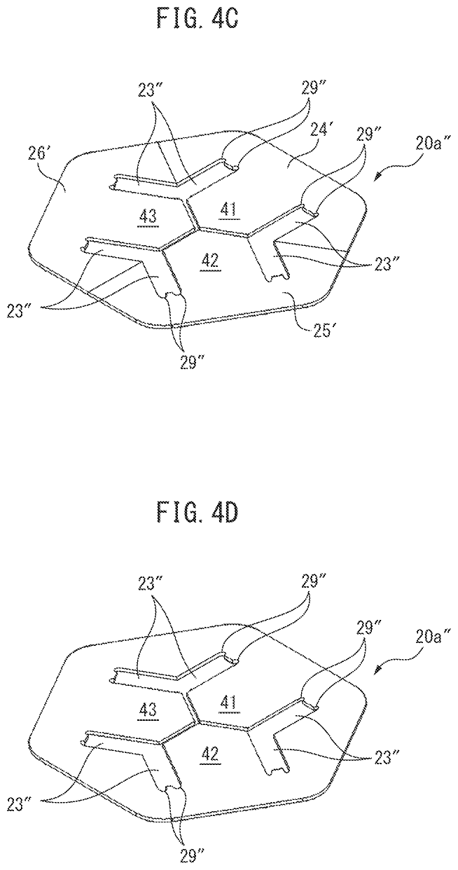

FIG. 4A is a perspective view of a reactor as an electromagnetic device according to a third embodiment, and FIG. 4B is a top view of the reactor. Outer peripheral iron core 20″ (core) of reactor 1″ is composed of a plurality of iron cores 41 to 43 arranged at equal intervals in the circumferential direction, and coils 31 to 33, which are inserted into slots 23″ formed on both sides of these iron cores 41 to 43. The coils 31 to 33 are surrounded by an insulating paper (not illustrated). The iron cores 41 to 43 are integrally formed with the outer peripheral iron core 20″ or are in contact with outer peripheral iron core 20″. It should be noted that the outer peripheral iron core 20″ may have another rotationally symmetrical shape, such as a circular shape.

In FIG. 4B, the outer peripheral iron core 20″ is composed of a plurality, for example, three, of outer peripheral iron core portions 24 to 26 divided at equal intervals in the circumferential direction. The outer peripheral iron core portions 24 to 26 are integrally formed with the iron cores 41 to 43, respectively. In this manner, when the outer peripheral iron core 20″ is composed of a plurality of outer peripheral iron core portions 24 to 26, even if the outer peripheral iron core 20″ is large, such an outer peripheral iron core 20″ can easily be produced.

The radially inner ends of the iron cores 41 to 43 are positioned near the center of the outer peripheral iron core 20″. In the drawings, the radially inner ends of each of the iron cores 41 to 43 converge toward the center of the outer peripheral iron core 20″ at a tip angle of approximately 120 degrees. The radially inner ends of the iron cores 41 to 43 are separated from each other via magnetically coupleable gaps 101 to 103.

In other words, the radially inner end of the iron core 41 is separated from the radially inner ends of the two adjacent iron cores 42, 43 via the gaps 101, 102, respectively. The same applies to the other iron cores 42, 43. The dimensions of the gaps 101 to 103 are equal to each other.

In the same manner as the embodiments described above, the outer peripheral iron core 20″ is formed by stacking a plurality of magnetic plates, such as iron plates, carbon steel plates, or electromagnetic steel plates. FIG. 4C is a view showing a magnetic plate used to form the core of the reactor. The magnetic plate 20a″ shown in FIG. 4C is divided into a plurality of magnetic plates 24′ to 26′ corresponding to the outer peripheral iron core portions 24 to 26. Each of the magnetic plates 24′ to 26′ has at least one recess 29″ formed in the slot 23″ in the same manner as described above.

The recesses 29″ extend at least partially from the bottom parts of slots 23″ radially outwardly of outer peripheral iron core 20″. In the third embodiment, recesses 29″ are formed in all of the plurality of magnetic plates 20a″ constituting the outer peripheral iron core 20″. In other words, the outer peripheral iron core 20″ is composed only of a plurality of magnetic plates 20a″ having recesses 29″, and no magnetic plates without recesses 29″ (not illustrated) are used.

In order to form the resin part 39″ shown in FIG. 4B, the entire outer peripheral iron core 20″, in which the coils 31 to 33 are inserted into the slots 23″, is immersed in liquid resin. The outer peripheral iron core 20″ is removed from the liquid resin in the axial direction of the outer peripheral iron core 20″, i.e., in the stacking direction of the magnetic plates. At this time, the liquid resin flows axially downward along the slots 23″ and recesses 29″. Most of the gas entrained in the liquid resin and/or trapped in slots 23″ by the insulating paper (not illustrated) flows axially downward along with the liquid resin. Part of the gas is then guided from the slots 23′″ to the recesses 29″, which have a lower flow resistance, together with the liquid resin, and remains in the recess 29′″ to form the voids A. It can be understood that the reactor 1″ formed in this manner also provides the same effects as described above.

Note that, as shown in FIG. 4D, the case in which the outer peripheral iron core 20 is formed by stacking magnetic plates 20a″, each of which is composed of a single member rather than a plurality of divided magnetic plates 24′ to 26′, is included in the scope of the present disclosure.

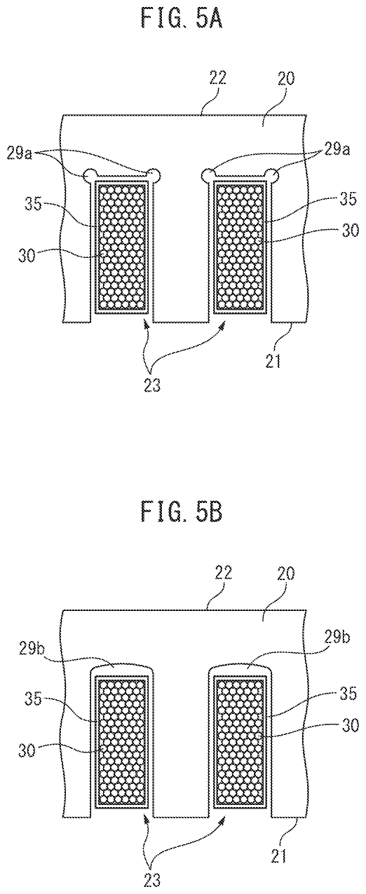

FIGS. 5A and 5B are views showing recesses according to other aspects. Though these drawings show recesses 29a, 29b formed in the core 20 of a linear motor, identical recesses 29a, 29b can be formed in the core 20′ of the motor and the core 20″ of the reactor 10″.

The recesses 29a shown in FIG. 5A are formed at both ends of the sides corresponding to the bottom sides of the slots 23. The recesses 29a partially extend toward the other surface 22 of the core 20 and partially extend toward other adjacent slots 23. Thus, the recesses 29a shown in FIG. 5A are spaced further from the slot 23 in the direction parallel to the other surface 22 than the recesses 29′ shown in FIG. 1.

Thus, since the insulation distance between the coils 30 and the core 20 can be better secured than in the case of FIG. 1, the occurrence of partial discharge can be further suppressed. Therefore, it can be understood that the reliability of the core 20 can be further enhanced.

Though two recesses 29a are formed in each slot 23 in FIGS. 1 and 5A, a single recess 29b is formed in each slot 23 in FIG. 5B. The recesses 29b shown in FIG. 5B extend in an arc-like shape from the entire side corresponding to the bottom parts of the slots 23 toward the other surface 22.

Specifically, in FIG. 5B, the width of a slot 23 parallel to other surface 22 is always greater than the width of a recess 29b. Thus, even when the recess 29b is formed, the coil 30 inserted into the slot 23 will not be displaced toward the other surface 22. Therefore, in FIG. 5B, the effects described above can be achieved while the coil 30 is maintained in an appropriate position. When a single recess is formed for each slot 23, a recess having another shape designed such that the width of the slot 23 is larger than the width of the recess may be adopted.

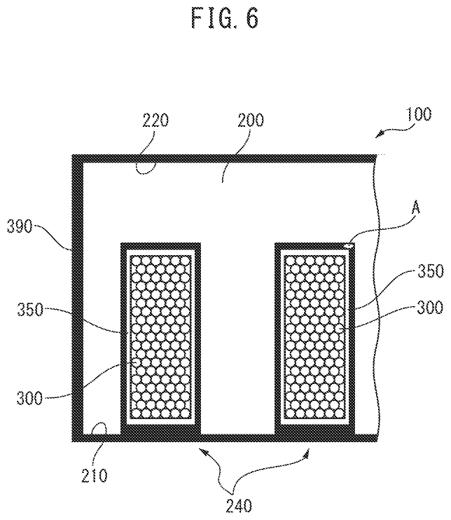

FIG. 6 is a partial cross-sectional view of the armature of a linear motor of the prior art. The armature 100 of the linear motor shown in FIG. 6 includes a core 200 in which a plurality of slots 230 are formed. Coils 300 covered by insulating paper 350 are inserted into the plurality of slots 230. Furthermore, a resin part 390 is formed around the entire circumference of the armature.

In order to form the resin part 390 shown in FIG. 6, the entire armature 100 is immersed in a liquid resin and then removed. Since the gas mixed in the liquid resin moves vertically upward, such gas remains in the bottom parts of the slot 230. The gas then forms voids A between the bottom parts of the slots 230 and the insulating paper 350 of the coils 300, as shown in FIG. 6

In this case, the voids A are formed in the armature 100 where the electric field concentrates. Thus, a sufficient insulation distance between the coil 300 and the core 200 cannot be secured. As a result, partial discharge occurs, and a highly reliable core 200 cannot be provided.

In contrast thereto, in the present disclosure, the voids A are formed in a concentrated manner in the recesses 29, 29′, 29″, 29a, 29b of the core 20, whereby the problem described above does not occur, and a highly reliable core 20 and an electromagnetic device comprising such a core can be provided. It is clear that the contents of the present disclosure are also applicable to electromagnetic devices other than motors, linear motors, and reactors.

As can be understood with reference to FIG. 6, the slots 230 and the coils 300 have similar shapes with each other. However, in the present disclosure, since the recesses 29, 29′, 29″ are formed in the slots 23, 23′, 23″, as shown in FIGS. 1, 3A, and 4B, the shapes of the slots 23, 23′, 23″ and the shapes of the coils 30, 30′, 31 to 33 are not similar to each other. Such cases are also included in the scope of the present disclosure.

### Aspects of the Present Disclosure

According to the first aspect, there is provided a core (20, 20′, 20″), wherein a plurality of slots (23, 23′, 23″) into which coils are to be inserted are formed in one surface (21) of the core, and recesses (29, 29′, 29″) extending toward the other surface (22) of the core are formed in bottom parts of the plurality of slots.

According to the second aspect, in the core of the first aspect, a shape of the coils is not similar to a shape of the slots in which the recesses are formed.

According to the third aspect, in the core of the first or second aspect, the core is formed by stacking a plurality of magnetic plates (20a, 20a′, 20a″, 20b), and among the plurality of magnetic plates, the recesses are formed only in the magnetic plates (20b) located on a middle portion of the core in a stacking direction.

According to the fourth aspect, in the core of any one of the first to third aspects, the core is formed by stacking a plurality of magnetic plates (20a, 20a′, 20a″, 20b), and the recesses are formed on all of the plurality of magnetic plates (20a′, 20a″).

According to the fifth aspect, there is provided an electromagnetic device, comprising the core according to any one of the first to fourth aspects, coils (30, 30′, 31 to 33) which are inserted into the plurality of slots, insulating paper (35, 35′) which encloses the coils, and an insulating resin part (39, 39′, 39″) for covering an entirety of the core.

According to the sixth aspect, in the electromagnetic device of the fifth aspect, the electromagnetic device is a linear motor (1), a motor (1′), or a reactor (1″).

### Effect of the Aspects

In the first aspect, since recesses are formed in the bottom parts of the slots into which the coils are to be inserted, when the resin part covering the entire armature including the core is formed, air is guided to the recesses to generate voids therein. Thus, even if partial discharge occurs near the voids, since the recesses are spaced from the location where the electric field concentrates, a sufficient insulation distance between the coil and the core can be secured, whereby partial discharge can be suppressed. Therefore, a highly reliable core can be provided.

In the second aspect, even if the coils and the slots are not similar to each other, the effects described above can be obtained.

In the third aspect, when the electromagnetic device comprising the core is a linear motor, since it is highly likely that voids are formed in the middle portion in the stacking direction, the number of magnetic plates in which recesses are formed can be minimized.

In the fourth aspect, in the case in which the electromagnetic device comprising the core is a motor or reactor, when the core is removed from the liquid resin in the axial direction, the gas entrained in the liquid resin is guided to the recesses, which have a lower flow resistance, together with the liquid resin. This is particularly advantageous when the electromagnetic device is a motor or reactor.

Though the embodiments of the present invention have been described above, a person skilled in the art would understand that various adjustments and changes can be made without deviating from the scope disclosed in the claims, which are described later.

### REFERENCE SIGNS LIST

1 linear motor (electromagnetic device)
1′ motor (electromagnetic device)
1″ reactor (electromagnetic device)
10 armature
10′ stator
20, 20′, 20″ core, outer peripheral iron core
20a, 20a′, 20a″, 20b magnetic plate
21 one surface
22 other surface
23, 23′, 23″ slot
24 to 26 outer peripheral iron core portion
29, 29′, 29″ recess
30, 30′, 31 to 33 coil
35, 35′ insulating paper
39, 39′, 39″ resin part (insulating resin part)
41 to 43 iron core
Z1 to Z3 region

1. A core, wherein
a plurality of slots into which coils are to be inserted are formed in one surface of the core, and
recesses extending toward the other surface of the core are formed in bottom parts of the plurality of slots.

2. The core according to claim 1, wherein a shape of the coils is not similar to a shape of the slots in which the recesses are formed.

3. The core according to claim 1 or 2, wherein the core is formed by stacking a plurality of magnetic plates, and
among the plurality of magnetic plates, the recesses are formed only in the magnetic plates located on a middle portion of the core in a stacking direction.

4. The core according to claim 1, wherein the core is formed by stacking a plurality of magnetic plates, and
the recesses are formed on all of the plurality of magnetic plates.

5. An electromagnetic device, comprising:
the core according to any one of claims 1 to 4,
coils which are inserted into the plurality of slots,
insulating paper which encloses the coils, and
an insulating resin part for covering an entirety of the core.

6. The electromagnetic device according to claim 5, wherein the electromagnetic device is a linear motor, a motor, or a reactor.
